(19) United States
(12) Patent Application Publication
(10) Pub. No.: US 2003/0011248 A1
(43) Pub. Date: Jan. 16, 2003

(54) Error recognition device for a multi-voltage vehicle electrical system

(76) Inventors: Michael Horbelt, Markgroeningen (DE); Joerg Jehlicka, Leonberg (DE); Andre Owerfeldt, Markgroeningen (DE)

Correspondence Address: KENYON & KENYON, ONE BROADWAY, NEW YORK, NY, 10004, US

(21) Appl. No.: 10/203,444

(22) PCT Filed: Dec. 6, 2001
(86) PCT No.: PCT/DE01/04601

(30) Foreign Application Priority Data
Dec. 8, 2000 (DE) 100 61 047.1

(51) Int. Cl. H01H 83/14

(52) U.S. Cl. 307/130; 340/661

(57) ABSTRACT

A device for fault detection in a multivoltage on-board system is described which has at least one detection device, which detects a supply potential (U0) which is supplied to a power distributor (16) for supplying electrical loads (22). The power distributor supplies power to at least one electrical load (22) via at least one output (9). An additional detection device is provided, which detects the output potential (U1) at the output (9). Fault detection means (24) generate a fault signal (26) if the output potential (U1) deviates from the supply potential (U0) by a certain value.

### BACKGROUND INFORMATION

The present invention relates to a device for fault detection in a multivoltage on-board system according to the preamble of the independent claim. In on-board systems having a plurality of electric consumers, for example, in motor vehicle on-board systems, there is the problem that a single 12 V voltage is no longer sufficient for power supply. Some consumers must be supplied with a voltage that is higher than 12 V; therefore, multivoltage on-board systems are known, which have two different voltage levels, one voltage level having a +12 V voltage with respect to ground and a second voltage level having a 36 V voltage, these voltages being nominal voltages. The connection between the two voltage levels is accomplished using a DC-DC converter.

Such a multivoltage on-board system in a motor vehicle is described in German Patent Application A 198 45 569. In this on-board system, the electric power is generated using a three-phase generator, which is driven by the vehicle engine and delivers an output voltage of 42 V (charge voltage). A 36 V (nominal voltage) battery is charged with this charge voltage. A 12 V battery is supplied with a 14 V charge voltage via a DC-DC converter. The electric consumers are connectable to either battery via appropriate switches, the 12 V battery supplying the traditional on-board system consumers, for example, incandescent lamps, while the 36 V battery is used for supplying high-power consumers such as, for example, windshield heaters. In the known on-board system the negative terminals of both batteries are connected to the same ground potential. Measures for preventing a short circuit between the 12 V and/or 14 V voltage level and the 36 V and/or 42 V voltage level are not addressed in the related art.

The object of the present invention is to provide fault detection, in particular, short circuit detection, possibly without additional intervention in existing signal power distributors. This object is achieved by the features of the independent claim.

### ADVANTAGES OF THE INVENTION

The device according to the present invention for fault detection in a multivoltage on-board system has a detection device, which detects a supply potential which is supplied to a power distributor for supplying power to electrical loads, which supplies power to at least one electrical load via an output. Furthermore, an additional detection device is provided, which detects the output potential at the output. Fault detection means, which generate a fault signal if the output potential deviates from the supply potential by a certain value, are provided. In particular, by comparing the supply voltage and the output voltage, even a high-resistance short circuit between a first voltage level (for example, 42 V) and a second voltage level (for example, 14 V) can be detected. Using voltage analysis, the complexity for measured value detection is reduced considerably, since, contrary to current measurement, the cable harness does not need to be unplugged. Furthermore, a special shunt does not need to be provided for each consumer. In addition, contrary to current measurement, one is not reliant on the flow of a reverse current.

In a useful refinement, the device for fault detection in a multivoltage on-board system detects additional output potentials with which additional loads are supplied with power by the power distributor for comparison with the supply potential. The output signals of the respective fault detection device are OR gated. If an output potential exceeds the supply potential, this indicates a short circuit. In this event an appropriate fault signal is generated, which may be analyzed to initiate countermeasures. This OR gating reduces the complexity of the wiring. A single signal line may be used for relaying the fault signal, for example, to a higher-level power distributor. The hardware complexity is minimized.

In a useful refinement, the device for fault detection includes a power supply for the fault detection means. Thus a comparator which performs the potential comparison may be used as a fault detection means. In order to reduce the quiescent current consumption, a switching means which activates or deactivates the power supply may be provided. This switching means may be activated via the same signal line over which the fault signal is also delivered. Thus, during the ramp-up phase (desired start of the motor vehicle), an activation signal is delivered via this line to activate the device for fault detection. When the device for fault detection reaches its normal operating state, this external activation signal is no longer required. The same supply lead can then be used for other purposes. This arrangement further simplifies the design of the device for fault detection.

In a useful refinement, at least one additional device for fault detection monitors the output potential of an additional power distributor. The error signal delivered is OR gated via the hard-wired arrangement with the fault signal of the first device for fault detection to be conveyed to a higher-level analyzing unit.

According to a useful refinement, the fault signal is a binary signal. If the output potential exceeds the supply potential by a given value for the first time, a signal change occurs from logical 1 state to logical 0 state. With the change in the signal state, a timer is started for a predefinable time period. Countermeasures are only initiated if the fault signal continues to have a level which characterizes a fault state after this time period has elapsed. Due to this initial suppression of the fault detection for a predefinable time period, brief voltage peaks associated with possible closing operations of electric consumers do not trigger a fault handling routine. Fault detection is improved in this way.

Further useful refinements result from the other dependent claims and from the description.

### DRAWING

An exemplary embodiment of the device for fault detection in a multivoltage on-board system is illustrated in the drawing and elucidated in detail in the description that follows.

FIG. 1 shows a structural arrangement of the device for fault detection in a multivoltage on-board system.

FIG. 2 illustrates the device for fault detection in detail.

FIG. 3 shows the possible interconnections in the case of multiple devices for fault detection.

### DETAILED DESCRIPTION OF THE EMBODIMENT

A 14 V signal power distributor 16 is supplied with a supply potential U0 via a 14 V supply voltage input 17. 14 V supply voltage input 17 is connected to a DC-DC converter 7 and to the positive pole of a first battery 14. First battery 14 is also connected to ground 15. A plurality of components are shown as examples in 14 V signal power distributor 16. A voltage limiter 11 is used for voltage surge protection. A 14 V load 22 is connectable to the supply potential via a switching means 18. An output potential U1 of first output 9 is tappable at the respective first output 9, through which the 14 V load is supplied. 14 V load 22 is connected to ground 15. A second load 22b is protected by a fuse 13. An additional 14 V load 22c may be activated via a relay 12. 14 V signal power distributor 16 exchanges data via a bus system 20. Output potential U1 at first output 9 is supplied to a fault detector 10 together with supply potential U0. A comparator 24, which compares supply potential U0 and output potential U1 and generates a fault signal 26 as a function of the comparison, is situated in fault detector 10. This fault signal 26 is supplied to a 42 V signal power distributor 28 via a signal line. This 42 V signal power distributor contains a time monitor 25, which, after a time period has elapsed, analyzes incoming fault signal 26 for a characteristic fault state. The output signal of time monitor 25 is supplied to a microcontroller 31, which initiates possible countermeasures as a function of this output signal, for example, in connection with a data exchange via bus system 20. Time monitor 25 may also be implemented directly by microcontroller 31, for example. A short circuit resistor 19 symbolizes a possible short circuit to be detected between the 14 V voltage level and the 42 V voltage level. 42 V signal power distributor 28 also includes two switching means 21, which are activatable via microcontroller 31, for example. The input of 42 V signal power distributor 28 is supplied with 42 V via 42 V supply voltage input 5. A 42 V load 23 may be supplied with power via switching means 21. The 42 V supply voltage is made available via a second battery 6 and a generator 8 connected in parallel with battery 6, and is connected to the 14 V voltage level via DC-DC converter 7.

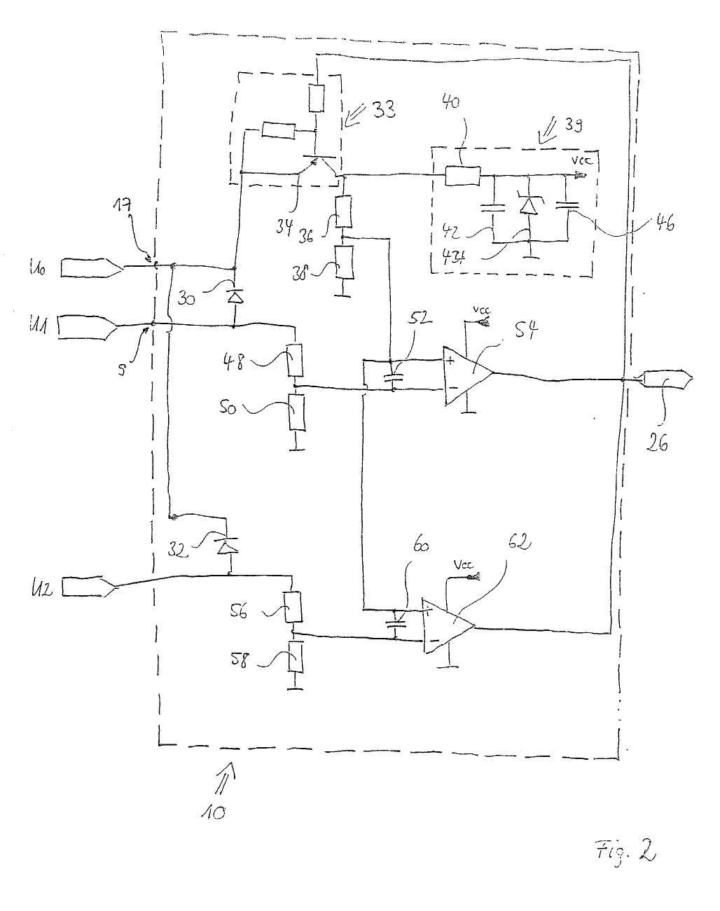

FIG. 2 shows fault detector 10 in more detail. Fault detector 10 receives supply potential U0 via input 17 and first output potential U1 via input 9. Both inputs 9, 17 are connected to a first diode 30, whose polarity is such that for a supply potential U0 that is more positive than first output potential U1, first diode 30 is polarized in the blocking direction. Supply potential U0 is supplied to a supply voltage generator 39 via switching unit 33 and the emitter-collector path of a transistor 34. Supply voltage generator 39 includes a third resistor 40, via which supply potential U0 is supplied to a parallel circuit of a first capacitor 42, a diode 44, and a second capacitor 46, connected to ground. Internal supply voltage VCC is provided as the output variable of supply voltage generator 39. Furthermore, a voltage divider, having a first resistor 36 and a second resistor 38, is provided, via which supply potential U0 is subdivided into the operating voltage range of a first comparator 54. Thus a voltage that is proportional to supply potential U0 is applied to the non-inverting input of first comparator 54 and to a non-inverting input of a second comparator 62, which is connected in parallel to first comparator 54. Output potential U1 of first output 9 is subdivided into the operating voltage range of first comparator 54 via another voltage divider, which has a fourth resistor 48 and a fifth resistor 50. A voltage that is proportional to output potential U1 of the first output is thus applied to the inverting input of first comparator 54. Second output potential U2 is supplied via another input of fault detector 10 and is subdivided into the operating voltage range of second comparator 62 in an additional voltage divider having a sixth resistor 56 and a seventh resistor 58, so that a voltage that is proportional to second output potential U2 of the second output is applied to the inverting input of second comparator 62. Capacitors 52, 60 are connected between the inverting and non-inverting inputs of comparators 54, 62, respectively, for filtering transients. If one of output potentials U1, U2 exceeds supply potential U0, at least one of comparators 54, 62 outputs a fault signal 26, which corresponds to the logical 0 state. Comparators 54, 62 are designed as open collector comparators in this example, which draw the output of comparators 54, 62 to ground potential when one of output potentials U1, U2 exceeds supply potential U0. The outputs of the two comparators 54, 62 are connected electrically conductively, so that, in connection with the open collector outputs, a hardwired logical OR gating is implemented. The output signals thus gated of comparators 54, 62 are output from fault detector 10 via fault signal 26. The respective signal line is also used as an input which is electrically conductively connected to the base of transistor 34 for activating switching unit 33.

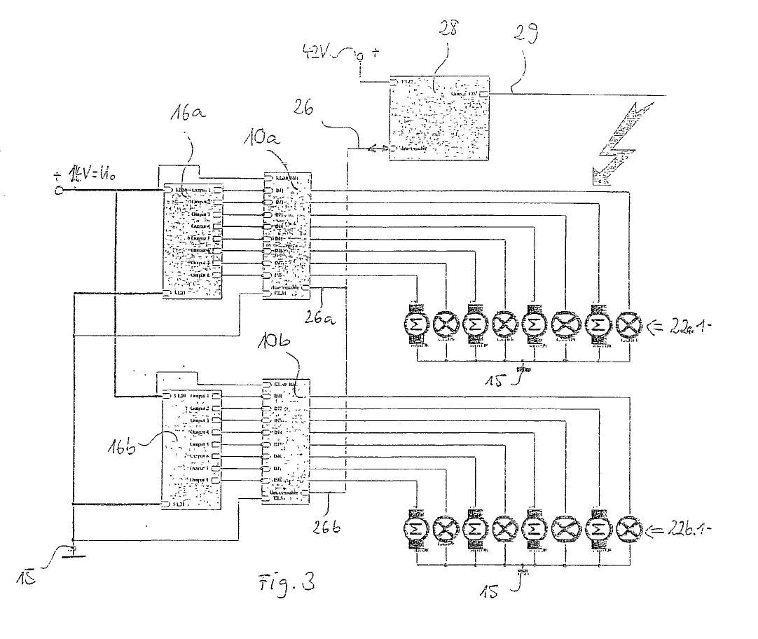

According to FIG. 3, two 14 V signal power distributors 16a, 16b are now provided, which are responsible for supplying eight loads 22a.1-8, 22b.1-8 with power. A fault detector 10a, 10b, which analyzes output potentials U1 to U8 for fault detection, is assigned to each of these 14 V signal power distributors 16a, 16b. Furthermore, these fault detectors 10a, 10b receive 14 V supply potential U0 (terminal 30) and ground potential 15 (terminal 31). Fault signals 26a, 26b of fault detectors 10a, 10b are electrically conductively connected and supplied to 42 V signal power distributor 28 as fault signal 26. Signal power distributor 28 is supplied with 42 V and activates, via 42 V output 29, a 42 V load (not shown), which may also be optionally activated externally via an additional switching means. The lightning symbolizes a short circuit to be detected between the 42 V consumer level and the 14 V consumer level.

Initially the device for fault detection is in rest operation.

Switching unit 33 and the corresponding transistor 34 are activated so that there is no electrically conductive connection between 14 V supply voltage input 17 and the input of supply voltage generator 39. The line via which fault signal 26 is output in the normal state has therefore a high resistance. Microcontroller 31 of 42 V signal power distributor 28 now generates, in connection with an appropriate activation command which was supplied via bus system 20 or was detected by 42 V signal power distributor 28 itself, an appropriate command signal for activating unit 27. Thereupon activating unit 27 brings line 26 to an operational readiness level, whereby transistor 34 of switching unit 33 is set into the ON state. This also activates supply voltage generator 39, which then makes available at its output an internal supply voltage VCC of 5 V, for example, for the two comparators 54, 62. Thus comparators 54, 62 are in operational readiness as fault detection means.

First comparator 54 compares whether first output potential U1 exceeds supply potential U0 by a certain value, for example, by 0.7 V. This value is equal to the voltage drop across the inverse diode of semiconductor 18 in the reverse direction. This value may be appropriately set via the voltage dividers formed by resistors 36, 38 and 48, 50. These voltage dividers are also used for bringing voltages U0, U1 to be detected into the operating range of comparator 54. The outputs of comparators 54, 62 are designed as open collector outputs. If first output potential U1 exceeds supply potential U0 by the predefinable value, the output of first comparator 54 changes its state from logical 1 to logical 0. In the logical 0 state the output of comparator 54 is drawn to ground even if the output of second comparator 62 still has a value of logical 1. Thus fault signal 26 changes its state from logical 1 to logical 0. A possible short circuit between the 14 V voltage level and the 42 V voltage level is thus detected, since in the normal fault-free case output potential U1 of 14 V consumer 22 is always lower than the potential of 14 V supply input 17. Supply potential U0 may only be exceeded in the event of a response to a short circuit.

For further analysis, fault signal 26 is supplied to 42 V signal power distributor 28. Time monitor 25 detects the flank change which occurs in the event of a fault from logical 1 to logical 0 signal state and thereupon starts a timer for 5 ms to 1 s, for example. A logical 0 fault signal within this time period indicating a fault is still ignored by microcontroller 31, whereby voltage surge peaks which may occur, for example, when 14 V consumers 22 are switched on/off are suppressed in particular. However, if, after this predefinable time period, fault signal 26 still has a characteristic fault state, i.e., it is still at value of logical 0, then microcontroller 31 recognizes a possible short circuit. Then microcontroller 31 initiates diagnostic and troubleshooting measures. Thus, for example, an appropriate fault message may be displayed via bus system 20. In order to protect consumers 22, 23, the power source and/or consumers 22, 23 may also be switched off. For diagnostic purposes, these consumers may also be switched off consecutively. If then first output potential U1 drops below supply potential U0 again, fault signal 26 changes its logical state from 0 to 1 and thus signals to microcontroller 31 that the fault has been successfully eliminated. Microcontroller 31 stores the information on which load 23 was last activated and thus probably caused the short circuit. This is output in a diagnostic cycle.

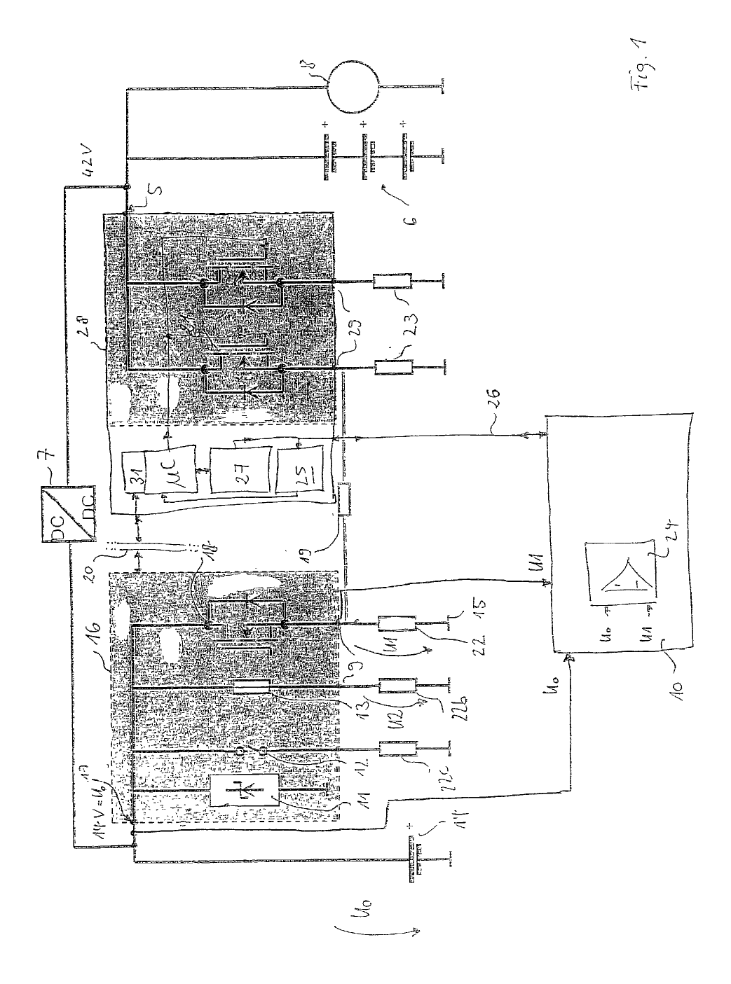

Using the circuit illustrated in FIG. 2, in principle any number of output potentials U1 to Un may be compared with the respective supply potential U0 of signal power distributor 16. If one of the output potentials U1 to Un exceeds supply potential U0, fault signal 26 assumes a state characteristic for a fault (logical 0). An appropriate cascading arrangement is illustrated in FIG. 3. Thus, a fault detector 10a, 10b, designed as described in FIG. 2, is associated with each 14 V signal power distributor 16a, 16b. Each output potential U1 to Un is thus monitored by comparing it to supply potential U0. The respective fault signals 26a, 26b are gated electrically conductively and supplied to 42 V signal power distributor 28 for analysis according to FIG. 1.

Fault detector 10 is designed as a separate component. Thus existing 14 V signal power distributors 16a, 16b may be left unchanged and retrofitted with respective fault detectors 10a, 10b. The outputs of 14 V loads 22 may be easily tapped from the cable harness of the 14 V load circuits (for example, using insulation piercing connecting devices, tee splices, or adapter plugs). Supply potential U0 should preferably be tapped in the immediate proximity of input 17. Basically, however, fault detector 10 might also be integrated into the respective signal power distributor 16.

Diodes 30, 32 situated between output potentials U1, U2 and supply potential U0 are to be used as an additional protection if, for example, no inverse diode of a switching means 12, through which otherwise a reverse current might briefly flow in the event of a fault, is provided. Thus consumers 22 in question are protected, in particular in the event of a low-resistance short circuit.

The device for fault detection is particularly well suited for a multivoltage on-board system, where the danger of a short circuit is relatively high. Such multivoltage on-board systems are provided in particular in automotive applications.

What is claimed is:

1. A device for fault detection in a multivoltage on-board system comprising a detection device (10), which detects a supply potential (U0) which is supplied to a power distributor (16), which supplies power to at least one electrical load (22) via at least one output (9); having an additional detection device (10), which detects the output potential (U1) at the output (9); having fault detection means (24), which generate a fault signal (26) if the output potential (U1) deviates from the supply potential (U0) by a certain value.

2. The device according to claim 1,
wherein at least one power supply (39) is provided for the fault detection means (24).

3. The device according to one of the preceding claims, wherein at least one switching means (33, 34) is provided which activates or de-activates the power supply (39).

4. The device according to one of the preceding claims, wherein the fault signal (26) is supplied to a power distributor (28) for additional fault analysis.

5. The device according to one of the preceding claims, wherein a monitoring device (25, 31) is provided, which analyzes the fault signal (26) regarding whether, after a predefinable time period, it assumes a state which is characteristic for a fault .

6. The device according to one of the preceding claims, wherein the monitoring device (25, 31) initiates countermeasures for fault diagnosis and/or troubleshooting if the fault signal (26) assumes a state which is characteristic for a fault after the predefinable time period.

7. The device according to one of the preceding claims, wherein electrical loads (23, 22) are switched off as a countermeasure.

8. The device according to one of the preceding claims, wherein a comparator (54, 62) is provided as the fault detection means.

9. The device according to one of the preceding claims, wherein a diode (30, 32) is situated between supply potential (U0) and output potential (U1).

10. The device according to one of the preceding claims, wherein at least one additional output potential (U2) of an additional output (9) is supplied to a fault detection means (62) for comparison with the supply potential (U0).

11. The device according to one of the preceding claims, wherein the outputs of the at least two comparators (54, 62) are connected to one another in an electrically conductive manner.

12. The device according to one of the preceding claims, wherein the switching unit (33) is controlled via the same line over which the fault signal (26) is conducted.
